(19) United States
(12) Patent Application Publication
(10) Pub. No.: US 2015/0285374 A1
(43) Pub. Date: Oct. 8, 2015

(54) SPRING MECHANISM FOR ELECTRIC SHIFT ACTUATOR

(71) Applicant: AGCO Corporation, Hesston, KS (US)

(72) Inventor: David W. O'Reilly, Hesston, KS (US)

(21) Appl. No.: 14/677,767

(22) Filed: Apr. 2, 2015

Related U.S. Application Data
(60) Provisional application No. 61/974,576, filed on Apr. 3, 2014.
(60) Provisional application No. 62/031,982, filed on Aug. 1, 2014.

(51) Int. Cl. F16H 61/32; F16H 61/04

(52) U.S. Cl. CPC F16H 61/32; F16H 61/04; F16H 2061/0474

(57) ABSTRACT

In one embodiment, a system comprising an electric actuator; a mechanical shift linkage; and a spring system operably configured as a conduit of force and motion between the electric actuator and the mechanical shift linkage when the mechanical shift linkage is not constrained from movement, the spring system energized by the electric actuator when the mechanical shift linkage is constrained from movement.

### CROSS REFERENCE TO RELATED APPLICATIONS

This application claims the benefit of U.S. Provisional Application Nos. 62/031,982, filed Aug. 1, 2014, and 61/974,576, filed Apr. 3, 2014, both of which are hereby incorporated by reference in their entirety.

### TECHNICAL FIELD

The present disclosure is generally related to mechanical transmissions.

### BACKGROUND

Multi-speed mechanical transmissions require a shifting of gears. One mechanism to accomplish shifting is by sliding a splined collar (also referred to herein as shift collar) out of mesh (engagement) with one gear and into mesh with an adjacent gear. Proper alignment of the splines is needed to complete this shifting action, which may be achieved by applying an axial force to the shift collar while providing rotational movement and eventual alignment. Inputs to the shift collar are traditionally provided by human-actuation via levers and cable or by hydraulic actuation using oil pressure and a piston-type cylinder. Both methods for providing inputs to the shift collar involve a prevailing or continuous axial force on the shift collar so that upon relatively slow rotation of the gearing, meshing or complete engagement of the spline occurs. Electric actuators have been attempted previously in such shifting applications, but with poor results due at least in part to poor stall characteristics of electric motor driven devices in general. For instance, reference is made to the schematic diagram of FIG. 1, which conceptually illustrates a conventional electric actuator system 10 comprising an electric actuator 12 serving as an input to a bi-directional rigid linkage 14 to cause movement of a load 16 (e.g., mesh of geartrain and shift collar). If the load 16 is greater than the force of the input 12, actuator life is compromised since the electric actuator realizes 100% of the load 16 for an excessive period of time.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that conceptually illustrates a conventional electric actuator system.

FIG. 2 is a schematic diagram that conceptually illustrates an embodiment of a shift buffer system.

FIG. 3 is a schematic diagram that illustrates an example vehicle in which an embodiment of a shift buffer system may be implemented.

FIG. 4A is a schematic diagram that illustrates, in fragmentary isometric, partial cut-away view, an embodiment of a portion of a transmission system.

FIG. 4B is a schematic diagram that illustrates, in fragmentary, partial isometric view, an embodiment of the shift buffer system of FIG. 4A.

FIG. 5 is a schematic diagram that illustrates, in fragmentary side elevation, cut-away view, an embodiment of a shift buffer system where an electric actuator strokes in one direction.

FIG. 6 is a schematic diagram that illustrates, in fragmentary side elevation, cut-away view, an embodiment of a shift buffer system where an electric actuator strokes in an opposing direction to that shown in FIG. 5.

FIG. 7 is a flow diagram that illustrates an embodiment of a shift buffer method.

### DESCRIPTION OF EXAMPLE EMBODIMENTS

### Overview

In one embodiment, a system comprising an electric actuator; a mechanical shift linkage; and a spring system operably configured as a conduit of force and motion between the electric actuator and the mechanical shift linkage when the mechanical shift linkage is not constrained from movement, the spring system energized by the electric actuator when the mechanical shift linkage is constrained from movement.

### Detailed Description

Certain embodiments of a shift buffer system and method are disclosed that enable an electric actuator to stroke the distance required to shift gears and then be de-energized even when shift collar or coupler splines are not aligned (e.g., partial engagement). Certain embodiments of a shift buffer system store the potential energy needed to accomplish shifting, independent of actual shifting by the electric actuator.

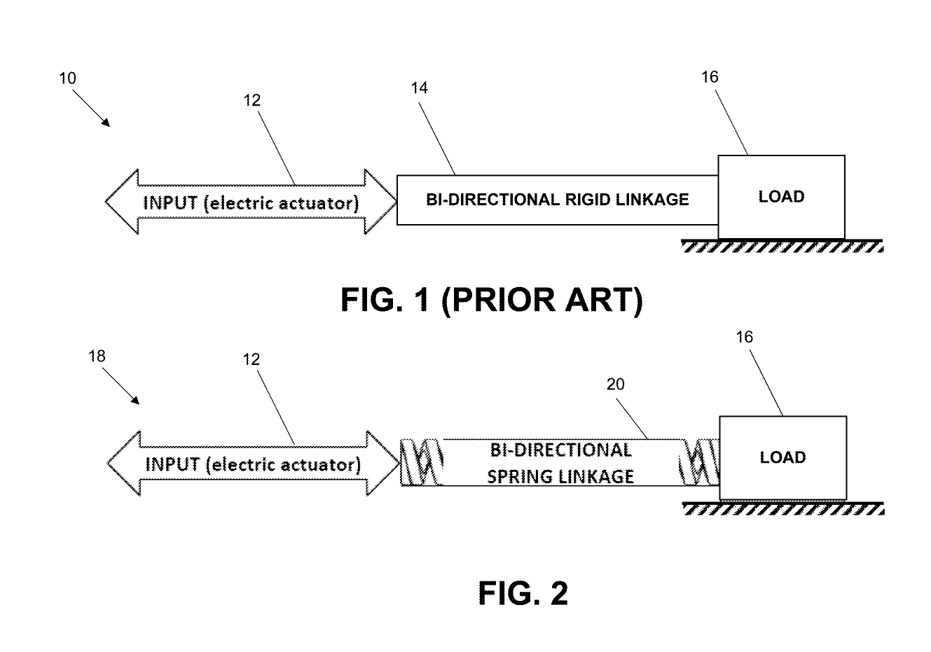

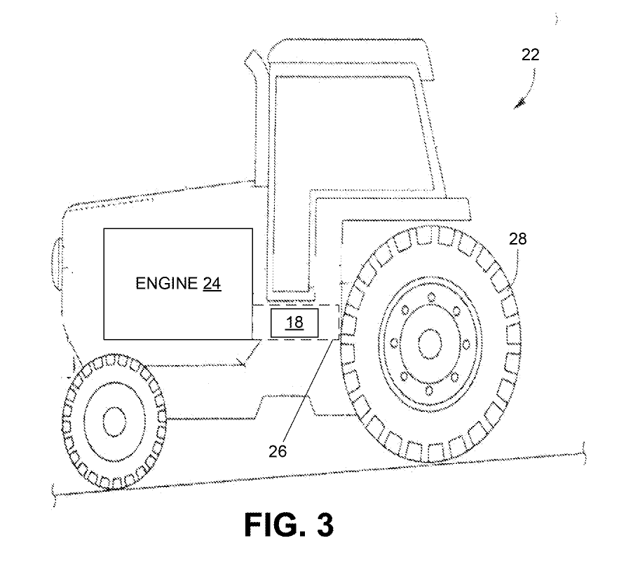

Digressing briefly, electric motor driven devices possess poor stall characteristics due to the rigid linkage structure of FIG. 1. For instance, electric motors draw relatively high current when stalled, resulting in heat and premature failures. In transmission systems, such stalls may result from the excessive load cause by incomplete alignment of splines of the shift coupler and geartrain. For instance, those less experienced in manual drive systems often experience the grinding of gears when improper clutch control is implemented. Another example from everyday life is, when parked on a hill and attempts are made to change gears of a manual transmission (e.g., without using the clutch), there is resistance to gear change as encountered by the operator of the vehicle. In each case, the underlying problem is excessive load (e.g., torque) across the splines involved with the gear coupling process. Now consider the use of an electric actuator for such implementations. Without adequate overload or heat protection, an electric actuator(s) will burn up based on the lock-out (no rotation) of the internal mechanisms of the electric actuator during the condition of excessive torque. Indeed, most transmission systems are hydraulic-based given the general consensus that electric actuators are ill-suited to such applications. To address these shortcomings, certain embodiments of a shift buffer system are disclosed herein that enable the electric actuator to be energized for implementing the shifting of the gear-change mechanism, and then be de-energized while one or more springs of the shift buffer system store the energy needed to complete engagement when permitted by certain conditions associated with loading and/or alignment. FIG. 2 conceptually illustrates an embodiment of a shift buffer system 18 that replaces the bi-directional rigid linkage 14 of FIG. 1 with a bi-directional spring linkage 20 that operably couples the electric actuator 12 to the load 16. In other words, the bi-directional spring linkage buffers the energy of the electric actuator 12, enabling a de-energization of the electric actuator or, in general, an operational de-coupling between the electric actuator 12 and the load 16 while enabling completion of the movement of the load 16 by the stored energy of the bi-directional spring linkage 20. For instance, considering the conditions set forth in association with FIG. 1, if the load 16 is greater than the force of the electric actuator 12, the actuator 12 realizes a limited load for a limited time, transitioning the kinetic energy of the actuator stroking action to the potential energy stored up by the bi-directional spring linkage 20 to complete the load movement (e.g., coupling or meshing of the geartrain with the shift coupler). Accordingly, the actuator life is not compromised when compared to the system 10 in FIG. 1. It should be appreciated by one having ordinary skill in the art, in the context of the present disclosure, that certain embodiments of a shift buffer system may include all or a subset of the components referenced in association with FIG. 2, or additional components.

Having summarized certain features of a shift buffer system of the present disclosure, reference will now be made in detail to the description of the disclosure as illustrated in the drawings. While the disclosure will be described in connection with these drawings, there is no intent to limit it to the embodiment or embodiments disclosed herein. For instance, though emphasis is placed on an electric linear actuator, other types of electric actuators (e.g., linear or non-linear, such as rotary or direct-acting magnetic solenoid-type actuators) may similarly deploy a shift buffer system to store energy needed to complete geartrain engagement while the electric actuator is de-energized. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

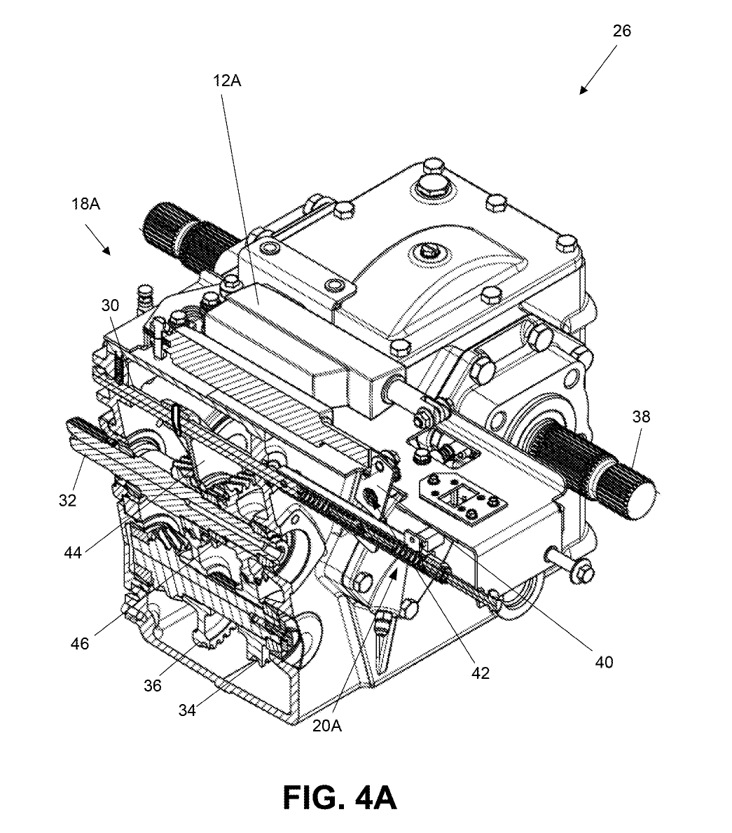

Reference is made to FIG. 3, which illustrates an example vehicle 22 in which an embodiment of a shift buffer system may be implemented. One having ordinary skill in the art should appreciate in the context of the present disclosure that the example vehicle 22, depicted in FIG. 3 as an agricultural machine (e.g., tractor), is merely illustrative, and that other vehicles (from the same or different industries) that use one or more electric actuators as part of their transmission system may be deployed with a shift buffer system as described herein, and hence are contemplated to be within the scope of the disclosure. The vehicle 22 is generally depicted with an engine 24 and a transmission system 26 that is operably coupled to the engine 24. The engine 24 may be embodied as gas or diesel-based engine (or other energy source), and is used to drive (directly or indirectly, such as via a hydraulic pump and motor, etc.) the transmission system 26 as is known. The transmission system 26 in turn drives an output shaft that, in combination with a differential and/or axle arrangement (or other drive system arrangement), drives the wheels 28 (and/or tracks in some embodiments) of the vehicle 22 to cause traversal across a road or field, as should be appreciated by one having ordinary skill in the art. It should be appreciated that other drive arrangements may be used and similarly benefit from the disclosed embodiments of the shift buffer system. A shift buffer system 18 is depicted generally in FIG. 3 as part of the transmission system 26, and is explained further below.

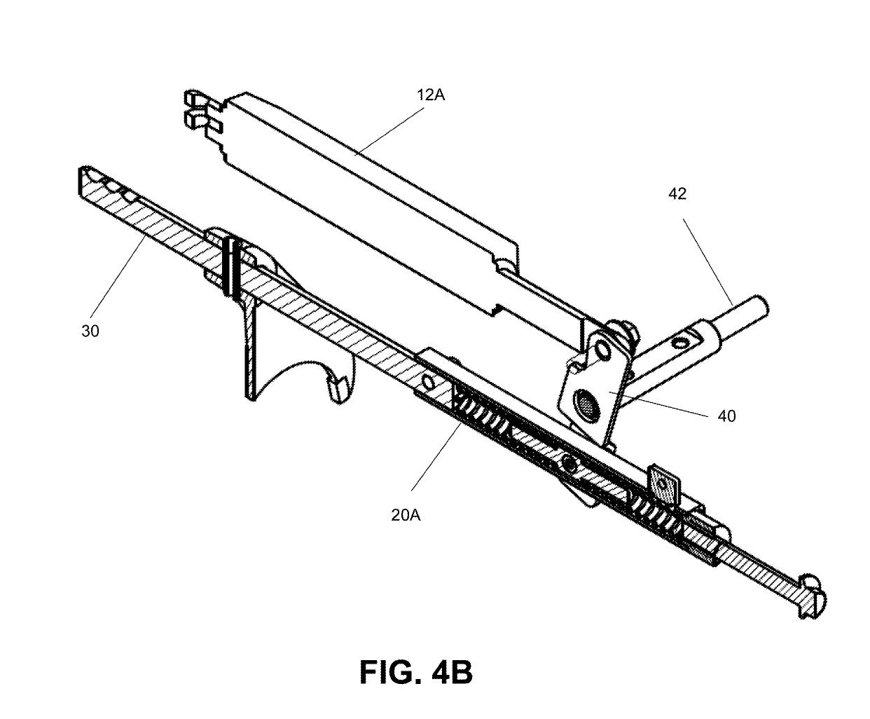

Referring now to FIG. 4A, shown is an example embodiment of a portion of the transmission system 26 shown generally in FIG. 3. It should be appreciated that the transmission system 26 shown in FIG. 4A is merely illustrative, and that in some embodiments, transmission systems of other designs and/or with different features may be used and hence are contemplated to be within the scope of the disclosure. The transmission system 26 comprises a shift buffer system 18A comprising, in one embodiment, a side-by-side, lever-action electric actuator 12A (one side shown in cut-away view, with the focus hereinafter on the cut-away portion with similar applicability in principle to the other side shift assembly), a bi-directional spring linkage 20A, and a mechanical shift linkage, such as in one embodiment, a slidable shift rod 30. In some embodiments, the shift buffer system 18A may comprise fewer components, or additional components of the transmission system 26. The transmission system 26 further comprises a rotatable input shaft 32, and first and second geartrains 34, 36. The transmission system 26 also comprises an output shaft 38 to operably couple to the engine 24 and drive train, respectively. The electric actuator 12A is disposed in FIG. 4A toward the top of the transmission system 26 (though not limited to this location), and is coupled to the bi-directional spring linkage 20A in one embodiment via a lever 40 that is pivotable about a pivot shaft 42. In some embodiments, a different arrangement of the bi-directional spring linkage 20A relative to the electric actuator 12A may be used. For instance, in one embodiment, an in-line, sliding-action (or in some embodiments, an in-line, side-by-side sliding action) assembly may be used wherein a bi-directional spring linkage, the shift rod, and the electric actuator are arranged in-line (e.g., axially in line, as opposed to a lever action). In the depicted embodiment, the bi-directional spring linkage 20A is coupled at one end to the shift rod 30. The shift rod 30 is coupled to the rotatable input shaft 32 via a shift fork 44 and shift coupler 46, described below. The first and second geartrains 34 and 36 are selectably coupled (e.g., as prompted via user input or automatically) by the assembly of the shift fork 44 and shift coupler 46, which is moved into respective engagement based on movement of the shift rod 30 as caused by actuation of the electric actuator 12A and, where needed, biasing by the bi-directional spring linkage 20A.

FIG. 4B shows a partial cut-away, fragmentary view of portions (e.g., one side of the side-by-side arrangement shown in FIG. 4A) of an example arrangement of the bi-directional spring linkage 20A, the shift rod 30 coupled to one end of the bi-directional spring linkage 20A, the lever 40 coupled to the bi-directional spring linkage 20A and pivotable about the pivot shaft 42 as influenced by the actuator 12A.

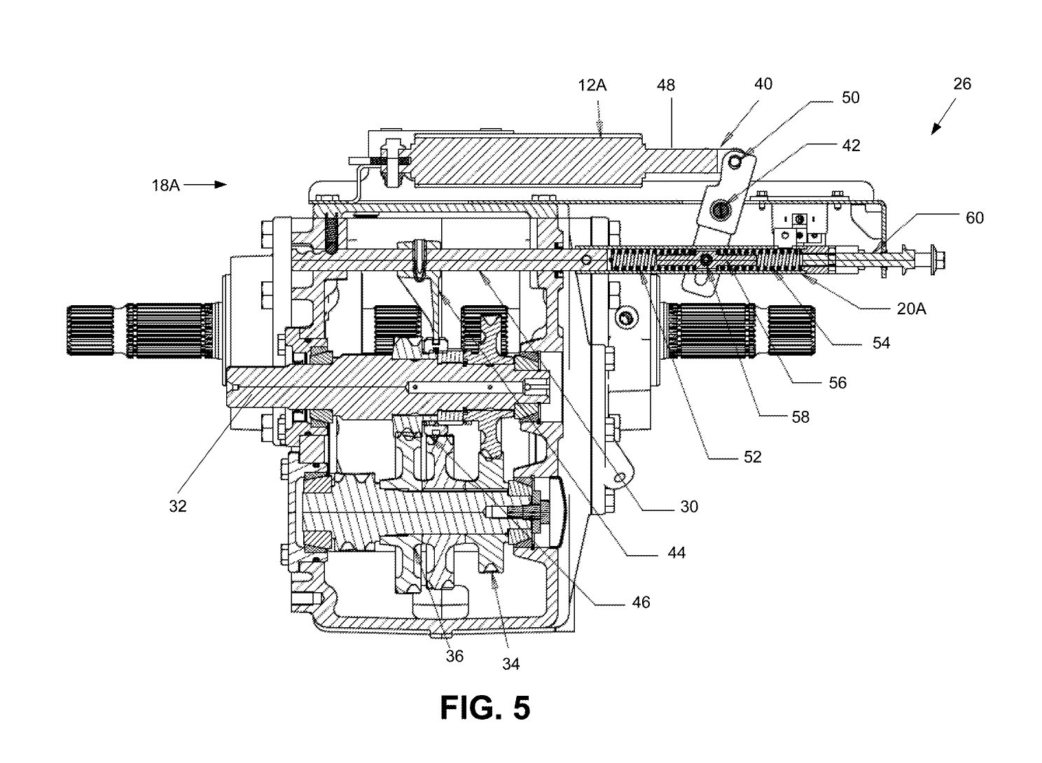

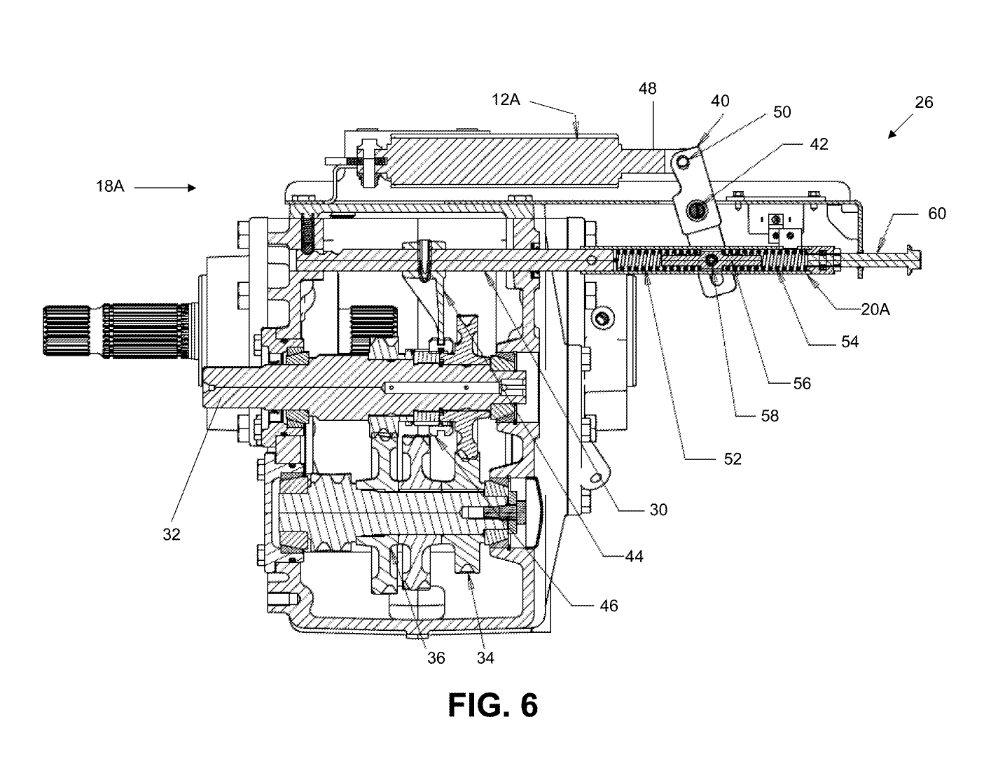

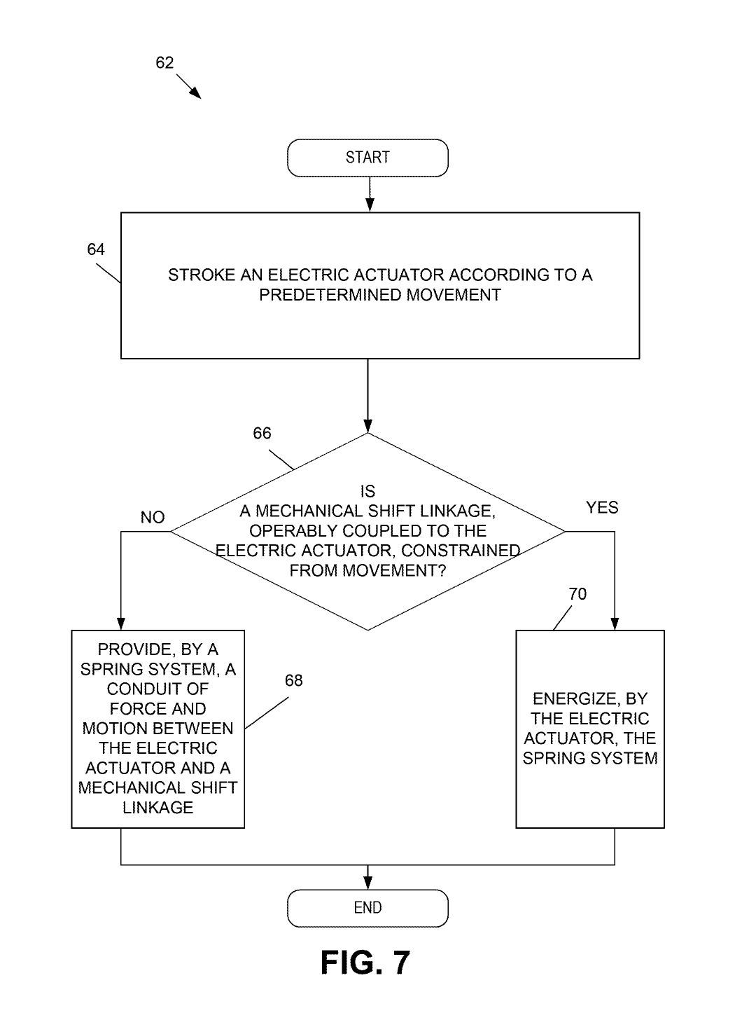

Turning attention to FIGS. 5-6, shown in fragmentary, partial cut-away, side-elevation view is the transmission system 26 of FIG. 4A as viewed from two opposing stroke positions. It should be appreciated that the transmission system 26 shown in FIGS. 5-6 is merely illustrative, and that in some embodiments, transmission systems of other designs and/or with different features may be used and hence are contemplated to be within the scope of the disclosure. With reference to FIGS. 5-6, the transmission system 26 comprises the shift buffer system 18A comprising the electric actuator 12A, the bi-directional spring linkage 20A, and the shift rod 30. The electric actuator 12A comprises a thrust rod 48 that is bi-directionally moveable according to the operation of well-known components within the electric actuator 12A. The bi-directional spring linkage 20A is coupled to the electric actuator 12A (e.g., to the thrust rod 48) via the lever 40. For instance, the lever 40 is secured to the thrust rod 48 via a pin 50, and rotates about the pivot shaft 42 that is also coupled to the other side of the shift assembly. The bi-directional spring linkage 20A (also referred to herein as a spring system) comprises a housing that encloses independently-acting shift-inward and shift-outward springs 52, 54. Note that inward and outward refer to the direction, relative to the transmission system body, of the compression action of the respective springs 52, 54. The dual, single-acting springs 52 and 54 enable the electric actuator 12A to stroke without stalling when the mechanical shift linkage does not freely move, while enabling rapid travel of the fork if the stall condition suddenly passes. Although the depicted embodiment uses dual springs acting in opposite direction under compression, some embodiments may use other designs. That is, in some embodiments, a single spring may be used, such as one acting under compression and tension. For instance, in one embodiment, a single, double-acting (e.g., deflects and develops force in a single direction) torsional spring of well-known construction that couples the shift rod 30 and the electric actuator 12A may be used. In some embodiments, a single, double-acting helical spring of well-known construction that couples the shift rod 30 to the electric actuator 12A may be used. Disposed in between the shift-inward and shift-outward springs 52, 54, respectively in FIG. 5, is a push-pull rod 56. The push-pull rod 56 is secured to the lever 40 via a pin 58. Accordingly, and referring specifically to FIG. 5, movement of the thrust rod 48 to the right (e.g., outward) in FIG. 5 of an energized electric actuator 12A causes pivoting movement of the lever 40, which rotates clockwise (in the depicted view) about the pivot shaft 42, resulting in a opposing movement (e.g., opposite to the direction of movement of the thrust rod 48) of the push-pull rod 56 (e.g., to the left or inward in FIG. 5). The push-pull rod 56 exerts a compressive force upon the shift-inward spring 52.

Referring specifically to FIG. 6, movement of the thrust rod 48 to the left (inward, or retraction) in FIG. 6 of an energized electric actuator 12A causes pivoting movement of the lever 40, which rotates counter-clockwise (as viewed in FIG. 6) about the pivot shaft 42, resulting in a opposing movement (e.g., opposite to the direction of movement of the thrust rod 48) of the push-pull rod 56 (e.g., to the right or outward in FIG. 6). The push-pull rod 56 exerts a compressive force upon the shift-outward spring 54. In effect, the movement of the lever 40, thrust rod 48, and push-pull rod 56 mimics a teeter-totter motion, with independent compressive forces upon the shift-inward and shift-outward springs 52, 54, respectively, differing from one another depending on the stroke direction.

Continuing, adjacent one end of the bi-directional spring linkage 20A is a linear guide shaft 60, which constrains motion of the assembly to linear (as opposed to side-to-side) movement. Adjacent the other end of the bi-directional spring linkage 20A is the shift rod 30. The shift rod 30 is bi-directionally moveable in coincidence with respective movement of the push-pull rod 56 and compressive force of the inward or outward springs 52, 54. Coupled to the shift rod 30 is the shift fork 44, which in turn is coupled to the shift coupler 46. The shift coupler 46 moves with the shift fork 44, and hence with the shift rod 30, and as is known, enables the input shaft 32 to be rotationally (or torsionally) engaged with one geartrain 34 or the other geartrain 36.

In one example operation, and referring to FIG. 6, when the electric actuator 12A is energized, based on input (e.g., operator input to switch gears, or automatically based on one or more conditions), the thrust rod 48 retracts (strokes inward or to the left in FIG. 6), and through coupling to the push-pull rod 56 via the lever 40, a teeter-totter affect results where the push-pull rod 56 compresses the shift-outward spring 54, drawing (“pulling”) the shift rod 30 outward or to the right in FIG. 6. This spring-action of the shift-outward spring 54 serves to store up energy from the electric actuator stroke to complete the shift engagement without compromising actuator life (e.g., due to stalls caused by a load that is greater than the force of the actuator input). The shift fork 44 and shift coupler 46 likewise are moved to the right (outward) in FIG. 6 along with the shift rod 30, resulting in dis-engagement with the second geartrain 36 and engagement with the first geartrain 34. Note that the electric actuator 12A (as is true of electro-magnetic devices in general) experiences an in-rush of current used in the creation of a magnetic field, the in-rush current subsiding (e.g., low-level current draw) when the motor of the actuator is in motion. If the motor stalls, the in-rush current state is maintained (or returned-to), resulting in overheating if the state of in-rush current occurs over an excessively long period of time. The shift-outward spring 54 enables the actuator 12A to be de-energized (e.g., zero current draw) or returned to a low-level current draw state, completing the work of the actuator 12A upon overcoming the load. In some circumstances (e.g., the load is less than the input), a complete engagement (e.g., from one gear to another gear and fully operational) may result without requiring compression (or significant compression) of the shift-outward spring 54. Where the load is greater than the input, the shift-outward spring 54 is compressed, storing up potential energy to be used to complete the engagement while the electric actuator 12A is de-energized, conserving actuator life.

A similar description of operations as set forth above applies for the configuration of FIG. 5. Referring to FIG. 5, when the electric actuator 12A is energized again, based on input (e.g., operator input to switch gears, or automatically based on one or more conditions), the thrust rod 48 strokes outward or to the right in FIG. 5), and through coupling to the push-pull rod 56 via the lever 40, a teeter-totter affect results, where the push-pull rod 56 compresses the shift-inward spring 52, pushing or biasing the shift rod 30 inward or to the left in FIG. 5. This spring-action of the shift-inward spring 52 serves to store up energy from the electric actuator stroke to complete shift engagement without compromising actuator life (e.g., due to stalls caused by a load that is greater than the force of the actuator input). The shift fork 44 and shift coupler 46 likewise are moved to the left (inward) in FIG. 5 along with the shift rod 30, resulting in dis-engagement from the first geartrain 34 and engagement with the second geartrain 36. The shift-inward spring 52 enables the electric actuator 12A to be de-energized or returned to a low-level current draw state when the motor is in motion and when there is not complete engagement, enabling completion of the work of the actuator 12A upon the shift-inward spring 52 overcoming the load. As with the shift-outward spring 54, the shift-inward spring 52 may not be compressed (or not significantly compressed) if the input is greater than the load, whereas for loads in excess of the input, the shift-inward spring 52 is compressed, storing up the energy of the actuator motion (now de-energized) until there is complete engagement of the second geartrain 36. Accordingly, in each case, the shift buffer system 18A stores the energy corresponding to the transitory stroke achieved by the electric actuator 12A, and uses the stored energy to overcome the resistance to cause complete engagement of the respective geartrain while the electric actuator 12A is de-energized; enabling significantly more cycles of operation when compared to an electric actuator 12A acting alone.

Although the shift buffer system 18A is shown in (and described according to) FIGS. 3-6 with the bi-directional spring linkage 20A coupled to the electric actuator 12A via a lever 40 according to a teeter-totter action, in some embodiments of a shift buffer system 18, and as noted previously, the electric actuator 12A may be positioned in-line with the bi-directional spring linkage 20A and the shift rod 30. For instance, the shift-inward and shift-outward springs 52, 54 (or a single spring in some embodiments) may be arranged in-line with a bi-directional moving member(s) (e.g., a thrust rod of an electric actuator, or one or more intermediary rods or members coupled in-line with the thrust rod, such as a push-pull rod), the bi-directional moving member(s) at least partially surrounded by the shift-outward spring 54 and coupled to both the shift-inward and shift-outward springs 52, 54 to enable compression of each depending on the stroke direction of the electric linear actuator 12A. In other words, in some embodiments, the shift buffering mechanism may be purely axial and linear in configuration and action.

Note that FIGS. 2-6 focus on the use of a single electric actuator, with similar applicability for the use of plural actuators and/or more than two (2) gears.

In view of the above description, it should be appreciated that one embodiment of a shift buffer method 62, comprises stroking an electric actuator according to a predetermined movement (64); if a mechanical shift linkage operably coupled to the electric actuator is not constrained from movement (66), providing, by a spring system, a conduit of force and motion between the electric actuator and the mechanical shift linkage (68), otherwise energizing, by the electric actuator, the spring system (70). In this manner, the electric actuator is activated for a predetermined movement and then deactivated (e.g., zero current or low current state), enabling the electric actuator to stroke without stalling when the mechanical shift linkage does not freely move. Further, the method 62 enables rapid travel of the fork if the stalled condition passes.

Any process descriptions or blocks in flow diagrams should be understood as representing steps in the process, and alternate implementations are included within the scope of the embodiments in which fewer or additional steps may be implemented, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the disclosed systems and methods have been described with reference to the example embodiments illustrated in the attached drawing figures, it is noted that equivalents may be employed and substitutions made herein without departing from the scope of the disclosure as protected by the following claims.

At least the following is claimed:

1. A system, comprising:
an electric actuator;
a mechanical shift linkage; and
a spring system operably configured as a conduit of force and motion between the electric actuator and the mechanical shift linkage when the mechanical shift linkage is not constrained from movement, the spring system energized by the electric actuator when the mechanical shift linkage is constrained from movement.

2. The system of claim 1, wherein the mechanical shift linkage is bi-directionally moveable.

3. The system of claim 1, wherein the electric actuator, the mechanical shift linkage, and the spring system comprise a linear mechanical shift mechanism.

4. The system of claim 1, wherein the electric actuator, the mechanical shift linkage, and the spring system comprise a rotary mechanical shift mechanism.

5. The system of claim 1, wherein the electric actuator comprises a linear electric actuator.

6. The system of claim 1, wherein the electric actuator comprises a rotary electric actuator.

7. The system of claim 1, wherein the spring system comprises torsional action.

8. The system of claim 1, wherein the spring system comprises linear action.

9. The system of claim 1, wherein the spring system comprises a single spring.

10. The system of claim 9, wherein the single spring comprises a double-acting torsional spring.

11. The system of claim 9, wherein the single spring comprises a double-acting helical spring.

12. The system of claim 1, wherein the spring system comprises dual single-acting springs.

13. The system of claim 12, wherein each of the springs provides a compressive force to effect respective movement of the mechanical shift linkage.

14. A system, comprising:
an electric actuator;
a mechanical shift linkage; and
a spring system operably coupled between the electric actuator and the mechanical shift linkage, the spring system enabling the electric actuator to stroke a predetermined movement and then deactivate independent of a load encountered by the mechanical shift linkage.

15. The system of claim 14, wherein the electric actuator, the mechanical shift linkage, and the spring system comprises an in-line sliding action arrangement.

16. The system of claim 15, further comprising a second electric actuator, a second mechanical shift linkage, and a second spring system, wherein the system overall comprises a side-by-side, in-line sliding action arrangement.

17. The system of claim 14, wherein the electric actuator, the mechanical shift linkage, and the spring system comprises a lever action arrangement.

18. The system of claim 17, further comprising a second electric actuator, a second mechanical shift linkage, and a second spring system, wherein the system overall comprises a side-by-side, lever action arrangement.

19. The system of claim 14, wherein the spring system enables the stroke without stalling when the mechanical shift linkage does not freely move.

20. A method, comprising:
stroking an electric actuator according to a predetermined movement; and
if a mechanical shift linkage operably coupled to the electric actuator is not constrained from movement, providing, by a spring system, a conduit of force and motion between the electric actuator and the mechanical shift linkage, otherwise energizing, by the electric actuator, the spring system.
